(19) United States
(12) Patent Application Publication
(10) Pub. No.: US 2002/0023029 A1
(43) Pub. Date: Feb. 21, 2002

(54) System and method for revenue chain management

(76) Inventor: Andrew M. Denver, Londonderry, NH (US)

Correspondence Address: Steven C. Becker, FOLEY & LARDNER, Firstar Center, 777 East Wisconsin Avenue, Milwaukee, WI, 53202-5367, US

(21) Appl. No.: 09/799,341

(22) Filed: Mar. 5, 2001

Related U.S. Application Data
(60) Provisional application No. 60/187,309, filed on Mar. 6, 2000.

(51) Int. Cl. G06F 17/60

(52) U.S. Cl. 705/35

(57) ABSTRACT

A revenue chain management system for providing revenue chain data for an event includes an attainment rule system, a first event measurement system, a second event measurement system, and a reporting system. The attainment rule system is configured to receive event data and to identify a recipient of a credit based upon a first of set of rules. The first event measurement system is configured to identify a credit earned by the recipient based upon a second set of rules. The second event measurement system is configured to identify a payment term of the earned credit based upon a third set of rules. The reporting system is configured to provide a revenue chain data output based on the recipient, the credit earned, and the payment term.

### CROSS-REFERENCE TO RELATED APPLICATIONS

The present application claims the benefit of U.S. Provisional Patent Application No. 60/187,309, filed Mar. 6, 2000, entitled “System and Method for Creation, Modification and Utilization of Variable Compensation Processing” to Andy Denver.

### FIELD OF THE INVENTION

The present application relates generally to revenue chain management systems and methods. More specifically, the present specification relates to a rule-based revenue chain management system.

### BACKGROUND OF THE INVENTION

Revenue chain management systems may include business-to-business Internet transactions, employee incentive programs, and other revenue chain management systems. Previous revenue chain management systems have been found to be inflexible and lacking in desired functionality. For example, prior art systems must be customized for each particular customer, and require a considerable amount of software coding time to produce the customized version.

Accordingly, what is needed is a revenue chain management system having increased flexibility as well as the ability for an operator having little software experience to customize data and systems as needed. Further, what is needed is a revenue chain management system which empowers the end user. Further still, there is a need for a system and method for revenue chain management which provides improved configurability, improved reporting, and other desired functionalities.

The teachings hereinbelow extend to those embodiments which fall within the scope of the appended claims, regardless of whether they accomplish one or more of the above-mentioned needs.

### SUMMARY OF THE INVENTION

According to one exemplary embodiment, a revenue chain management system for providing revenue chain data for an event includes an attainment rule system, a first event measurement system, a second event measurement system, and a reporting system. The attainment rule system is configured to receive event data and to identify a recipient of a credit based upon a first of set of rules. The first event measurement system is configured to identify a credit earned by the recipient based upon a second set of rules. The second event measurement system is configured to identify a payment term of the earned credit based upon a third set of rules. The reporting system is configured to provide a revenue chain data output based on the recipient, the credit earned, and the payment term.

According to another exemplary embodiment, a method of providing revenue chain data for an event based upon event data is provided. The revenue chain data includes a credit recipient, a credit earned, and a payment term. The method includes identifying the recipient of a credit based upon a first rule, calculating the credit earned by the recipient based upon a second rule, and identifying the payment term of the earned credit based upon a third rule. The method further includes receiving a rule editing command from an operator and editing at least one of the first, second, and third rules based on the rule editing command.

According to yet another exemplary embodiment, a computerized system for providing revenue chain data based upon event data includes a means for identifying the recipient of a credit based upon a first rule and a means for calculating the credit earned by the recipient based upon a second rule. The system further includes a means for identifying the payment term of the earned credit based upon a third rule and a means for receiving rule editing commands from an operator and editing the first, second, and third rules based on the rule editing command.

### BRIEF DESCRIPTION OF THE DRAWINGS

The invention will become more fully understood from the following detailed description, taken in conjunction with the accompanying drawings, wherein like reference numerals refer to like parts, in which:

FIG. 1 is a block diagram of a revenue chain management system according to an exemplary embodiment; and

FIG. 2 is a flow diagram illustrating a system and method for revenue chain management, according to an exemplary embodiment.

### DETAILED DESCRIPTION OF EXEMPLARY EMBODIMENTS

The exemplary embodiment includes attainment rules, which define the various parts of how the system works. An illustrative embodiment is entirely driven by the rules. Rules are used in every phase of the system. Such rules include identifying a recipient of a credit for an activity, different kind of credits in different amounts, etc. There are plan rules which define who should get paid or more specifically what someone is owed. There are also adjustments and exception handling.

Another type of rules is award rules which describe under what conditions someone is paid, including when they are paid, and other requirements. Finally, there are payment rules which typically refer to financial management systems (e.g., bookkeeping systems, payroll systems, etc.), such as, whether someone has been paid.

One embodiment of the invention has a singular code base wherein it is not necessary to change the code base for each customer. However, the customer is fully capable of modifying whatever parts of the system they need.

The components of the illustrative embodiment include the run-time engine which provides the data base and the access (e.g., via an XML interface) and other standard requirements. Part of the system can be in a data base neutral language, such as, Java or C++. The system can use any type of relational, object oriented, or knowledge-based database, such as, Sybase, Oracle or Informix. The illustrative embodiment includes real-time capability including transaction capturing and posting of the events., Transaction capturing includes gathering the data from various persons and entities (at any geographic locations) and docketing those transactions for later use. Posting involves actual batch running of the database and typically comes in two parts.

The first part is a run, which is performed nightly or at other periodic times, during which the actions are transactionally posted. The second part is when the data is actually sent to payroll or becomes payable, which is the financial posting of the data (analogous to payday). There is no time restriction for either of these posting events. In this way, the exemplary embodiment fits into any financial system and allows the financial back-end of the system to mesh into the present installed payroll and financial management system at any given organization.

Advantageously, the rule system provides flexibility. Prior art systems must be customized for each particular customer, and require a good deal of coding time to produce the customized version. The exemplary embodiment avoids this by allowing flexibility as well as the ability for the end customer to customize data and systems as needed. Therefore, the exemplary embodiment is customer-configurable and empowers the end user. The time incurred for developing this system is very small.

Another feature of the exemplary embodiment is an ability to build libraries of business rules and other rules for customers to pick and choose for their specific use. This library of rules can be changed, modified and distributed as necessary.

Another feature of the exemplary embodiment is a rule editing system which provides a user interface to allow customers to quickly and easily modify the rule system. Such rule editing systems include wizard functionality to create systems when given information from the customer. Such a system then establishes certain data pieces and rule bases and establishes the rules that include a mapping from the present rules to the customer-specific rules.

Another feature of the exemplary embodiment is modularity. Since the entire system is rule based, interdependencies are easily created and integrated, and the various pieces may be exchanged and plugged in.

An exemplary method begins when a sale is made by a party. The first rules which are applied are attainment rules which define “who gets the credit?”. These are typically given by business rules. This is where the event is captured.

The next section is where the event is measured and compared to quotas, goals and other plans which define what the party is to attain. A distinction here is made between transaction processing which for example is what is “earned” versus payment processing which is for what is “paid”. These two amounts may differ.

The final section of this example includes event handling which is the payment component. Here the illustrative embodiment can plug into existing payroll or payment systems.

The system also has the advantages that any part of the system can create a report for any reason, allowing tracking and analysis for many different reasons. Examples include quotas, cross-selling, market penetration data, cash flow, tax data, etc.

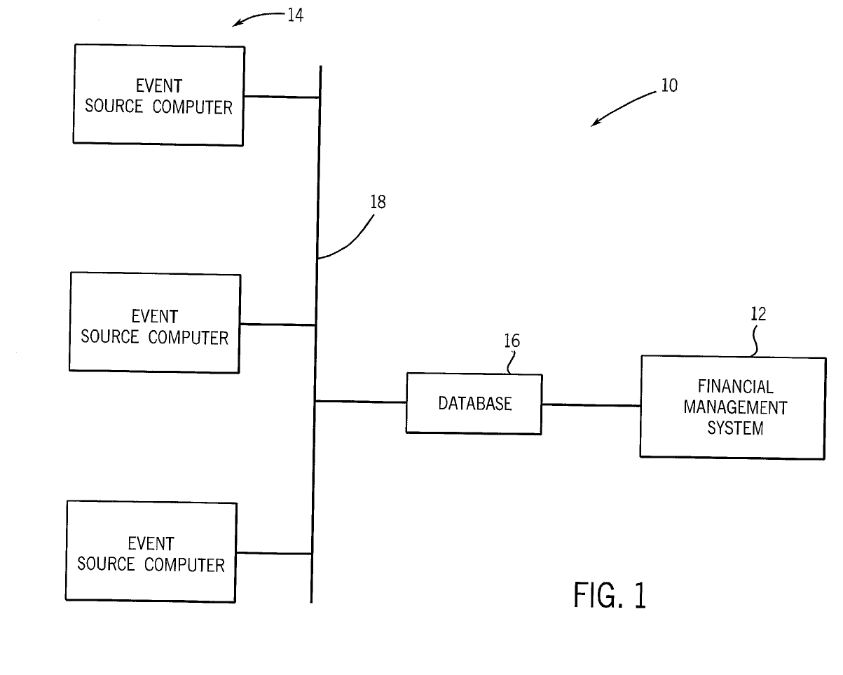

Referring now to FIG. 1, an exemplary revenue chain management system 10 is shown. System 10 advantageously utilizes an existing financial management system 1 2 and existing event source computers 14. A database 16 is provided as a modular insertion to existing systems 12 and 14 and may include various hardware and/or software components.

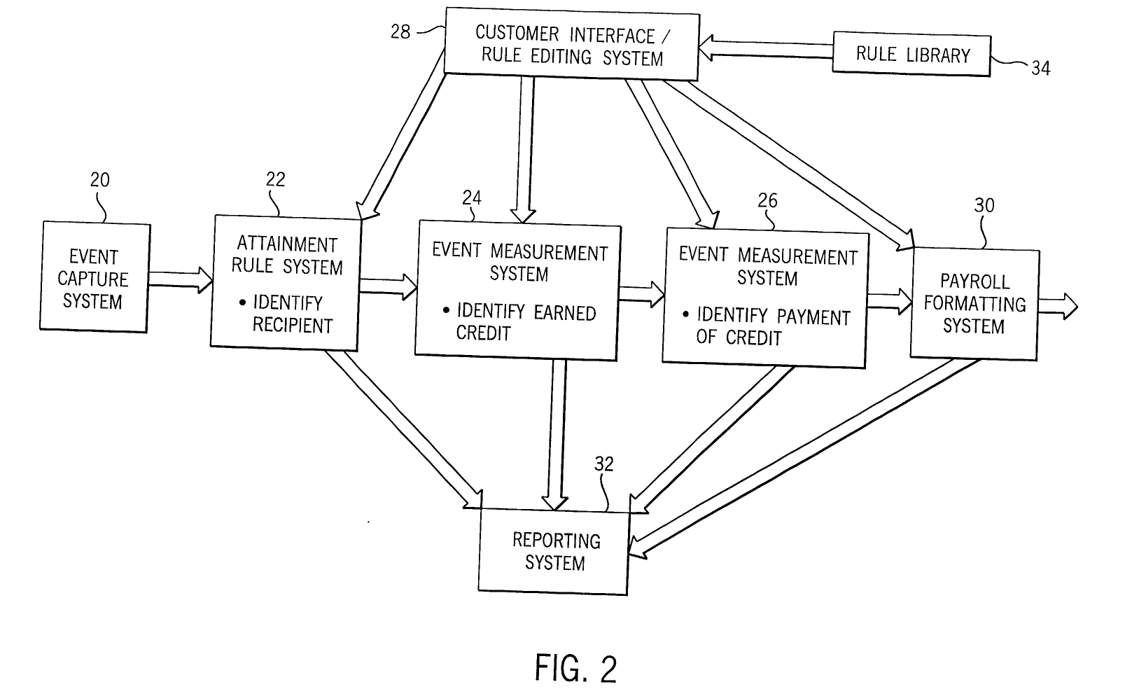

Database 16 includes a run-time engine which provides database storage and access functionality for revenue chain management system 10. At least part of database 16 is programmed in a database-neutral language, such as, JAVA or C++, in this exemplary embodiment. Database 16 may be any type of relational, object-oriented, or knowledge-based database (e.g., a Sybase, an Oracle database, an Informix database, etc.). Database 16 is operable in real time to provide the functions disclosed in the flow diagram of FIG. 2 below.

Event source computers 14 are configured to provide event data via a communication link 18 (e.g., the Internet, an intranet, wireless protocol, etc.). The event may be a sale, a transaction, etc. Database 16 is configured to provide revenue chain data to existing financial management system 12.

Referring now to FIG. 2, a flow diagram operable in computer software and/or hardware on database 16 (FIG. 1) will now be described. An event capture system 20 is operable to capture events from an outside source, such as, event source computers 14 (FIG. 1). Event capture system 20 may be configured to perform periodic “runs” (e.g., weekly, nightly, hourly, or at other periodic times) during which events are posted or stored in database 16. For example, if a sale is made from one party to another party, event capture system 20 downloads the sale, immediately or periodically, and stores the sale data as event data in database 16. Event capture system 20 is configured to capture transactions from various persons and entities at any geographic location and to post or docket these transactions in database 16 for later use.

Database 16 periodically or upon command provides the captured events to one or more of an attainment rule system 22, a first event measurement system 24, and a second event measurement system 26. Each of systems 22, 24, and 26 operates based on one or more rules. Advantageously, the rules in systems 22, 24, and 26 have a singular code base wherein it is not necessary to change the code base for each customer. By using a customer interface/rule editing system 28, a customer is capable of modifying the rules upon which systems 22, 24, and 26 operate.

Attainment rule system 22 is configured to receive event data either from event capture system 22 or from database 16 and to identify a recipient of a credit based upon a first set of rules. The first set of rules includes rules to identify the recipient of a credit for the event.

First event measurement system 24 is configured to identify a credit earned by the identified recipient based upon a second set of rules. For example, this second set of rules may identify the amount of credit given to a recipient and the kind of credit given to the recipient. The second set of rules may include quotas, goals and other plans which define how much credit and what type of credit the recipient is to attain for the event.

Second event measurement system 26 is configured to identify a payment term of the earned credit based upon a third set of rules. The payment term may include under what conditions the recipient is to be paid, including when the recipient is to be paid the credit, and other requirements. The third set of rules includes an identification of recipient payment, while the second set of rules includes an identification of a credit being earned. These two quantities may differ at different times.

A payroll formatting system 30 is configured to receive revenue chain data, such as, credit recipient, credit earned, and payment term, and format the revenue chain data for use by existing financial management system 12. Payroll formatting system 30 may include yet another set of rules, such as, payment rules, which typically refer to financial management functions indicating whether and how much a recipient has been paid. Payroll formatting system 30 is configured to financially post one or more components of revenue chain data upon command, periodically, or based on other triggering factors.

A reporting system 32 is configured to provide revenue chain data output based on such factors as the identified recipient, the credit earned, and the payment terms. Reporting system 32 may be integral with payroll formatting system 30. Reporting system 32 may provide reports in hard copy, electronically, or by other media. Reporting system 32 is configured to allow operator-configured tracking and analysis based on different criteria, such as, quotas, cross-selling, market penetration data, cash flow, tax data, etc.

As mentioned, rules may be used in systems 22, 24, 26, and 30, and even in reporting system 32. The rules may include adjustments and exception handling. The rule system provides flexibility such that a customer, in particular a customer not having a software background, may utilize customer interface/rule editing system 28 to update rules as desired criteria change. Rule editing system 28 is configured to receive a rule editing command from an operator and to edit at least one of the rules in systems 22, 24, and 26, and systems 30 and 32. Rule editing system 28 is configured to interface with an operator, such as, a customer, to allow reconfiguration of revenue chain management system 10 in a short period of time.

System 10 may advantageously include a rule library 34 which includes one or more libraries of rules from which a customer may select. Rule editing system 28 is configured to receive one or more rules from rule library 34 and to generate the rule editing command based on the received rules. Rule library 34 can be changed, modified, and distributed as necessary.

Customer interface 28 may further include a wizard functionality to assist the customer in a step-by-step method to configure and reconfigure rules for system 1 0 and for storage in rule library 34. Customer interface 28 may further provide a mapping from the existing rules in systems 22, 24, 26, 30, and 32 to the new rules selected by the customer. Rule editing system 28 may include an XML (extensible markup language)-based interface, or other ruled editing systems.

Advantageously, system 10 is modular, wherein interdependencies among rules are easily created and integrated within system 10 using customer interface 28.

While the exemplary embodiments illustrated in the FIGS. and described above are presently preferred, it should be understood that these embodiments are offered by way of example only. Accordingly, the present invention is not limited to a particular embodiment, but extends to various modifications that nevertheless fall within the scope of the appended claims.

What is claimed is:

1. A revenue chain management system for providing revenue chain data for an event, comprising:
an attainment rule system configured to receive event data and to identify a recipient of a credit based upon a first set of rules;
a first event measurement system configured to identify a credit earned by the recipient based upon a second set of rules;
a second event measurement system configured to identify a payment term of the earned credit based upon a third set of rules; and
a reporting system configured to provide a revenue chain data output based on the recipient, the credit earned, and the payment term.

2. The revenue chain management system of claim 1, further comprising a rule editing system configured to receive a rule editing command from an operator and to edit at least one of the first, second, and third sets of rules.

3. The revenue chain management system of claim 1, wherein the rule editing system is configured to edit all of the first, second, and third sets of rules.

4. The revenue chain management system of claim 2, wherein the rule editing system is configured to interface with the operator via a wizard function.

5. The revenue chain management system of claim 2, further comprising a rule library, wherein the rule editing system is configured to receive a rule from the rule library and to generate the rule editing command based on the received rule.

6. The revenue chain management system of claim 1, further comprising a reporting system coupled to the attainment rule system and the first and second event measurement systems, wherein the reporting system is configured to receive data from the attainment rule system and the first and second event measurement systems and to generate a report based on the data.

7. The revenue chain management system of claim 2, wherein the rule editing system includes an XML interface.

8. The revenue chain management system of claim 1, further comprising an event capture system configured to capture the event and to generate the event data.

9. The revenue chain management system of claim 8, wherein the event is captured from a remote geographic location.

10. A method of providing revenue chain data for an event based upon event data, wherein the revenue chain data includes a credit recipient, a credit earned, and a payment term, comprising:
identifying the recipient of a credit based upon a first rule;
calculating the credit earned by the recipient based upon a second rule;
identifying the payment term of the earned credit based upon a third rule; and
receiving a rule editing command from an operator and editing at least one of the first, second, and third rules based on the rule editing command.

11. The method of claim 10, further comprising providing the revenue chain data output based on the recipient, the credit earned, and the payment term.

12. The method of claim 10, wherein the step of receiving includes receiving rule editing commands for each of the first, second, and third rules.

13. The method of claim 10, wherein the step of receiving a rule editing command includes operating a wizard function to interface with the operator.

14. The method of claim 10, further comprising receiving a rule from a rule library and generating the rule editing command based on the received rule.

15. The method of claim 10, further comprising receiving data from the attainment rule system and the first and second event measurement systems and generating a report based on the data.

16. A computerized system for providing revenue chain data based upon event data, comprising:
means for identifying the recipient of a credit based upon a first rule;
means for calculating the credit earned by the recipient based upon a second rule;
means for identifying the payment term of the earned credit based upon a third rule; and
means for receiving rule editing commands from an operator and editing the first, second, and third rules based on the rule editing command.

17. The system of claim 16, further comprising means for providing a revenue chain data output based on the recipient, the credit earned, and the payment term.

18. The system of claim 16, wherein the means for receiving a rule editing command includes a wizard function to interface with the operator.

19. The system of claim 16, further comprising means for receiving a rule from a rule library and means for generating the rule editing command based on the received rule.

20. The system of claim 16, further comprising means for receiving data from the attainment rule system and the first and second event measurement systems and means for generating a report based on the data.
